(19) United States
(12) Patent Application Publication
(10) Pub. No.: US 2025/0219740 A1
(43) Pub. Date: Jul. 3, 2025

(54) COHERENT RECEPTION OF ON/OFF KEYING AND PULSE POSITION MODULATIONS

(71) Applicant: Intel Corporation, Santa Clara, CA (US)

(72) Inventors: Daniel Zeleznikar, Strongsville, OH (US); Sundar Krishnamurthy, Dublin, CA (US); Deepak Dasalukunte, Beaverton, OR (US); Ahmet Kirac, San Jose, CA (US); Jie Zhu, San Jose, CA (US); Conor O'Keeffe, Cork (IE); Finbarr O'Regan, Innishannon (IE); Ricard Menchon Enrich, Barcelona (ES)

(21) Appl. No.: 18/397,271

(22) Filed: Dec. 27, 2023

(51) Int. Cl. H04B 10/61

(52) U.S. Cl. CPC H04B 10/6165; H04B 10/612

(57) ABSTRACT

An optical receiver implements a method to provide a digital output of a received on-off keyed optical signal. The method includes receiving an on-off keyed optical signal via a coherent optical front-end receiver utilizing a locally mixed laser LO for a reference signal to perform quadrature detection of the optical signal to generate an electrical signal, performing symbol/slot timing recovery on the electrical signal using a timing error detector, performing carrier frequency and phase recovery on a symbol/slot signal to generate a frequency and phase recovered signal, and demodulating the frequency and phase recovered signal via a demodulation circuit to provide a digital output representative of the received on-off keyed optical signal.

### BACKGROUND

Optical on/off-keying (OOK) utilizes a signal that have two states that are designated as on or off. Data is encoded using OOK to modulate an optical signal and then decoded by demodulating the signal when received. Each state represents a binary value of zero or one. Demodulation traditionally utilizes a direct detection receiver architecture due to its simplicity. Pulse-position modulation (PPM) can be considered an extension of OOK wherein the encoding selects a particular timeslot in a range of possible timeslots where a transmitted signal is turned on versus turned off. Furthermore, OOK modulation is only one protocol type, and newer optical communications transceivers tend to utilize phase-shift keying (PSK) modulation types due to greater spectral efficiency. With PSK modulation types, demodulators must be able to detect and recover optical signal phase measurements to continuously track and recover an optical carrier phase (termed “coherent”). With such PSK modulation, direct detection receiver architectures are not sufficient.

### BRIEF DESCRIPTION OF THE DRAWINGS

FIG. 1 is a block diagram of an improved coherent optical receiver front end according to an example embodiment.

FIG. 2 is a block diagram illustrating a receiver system that includes receiver front end providing output to further circuitry for producing a final digital output representative of data encoded in the received optical signal according to an example embodiment.

FIG. 3 is a block diagram of the symbol/slot timing recovery circuit according to an example embodiment.

FIG. 4 is a block diagram of a demodulation/detection circuit according to an example embodiment.

FIG. 5 is a block circuit diagram illustrating a polarization-invariant optical front end according to an example embodiment.

FIG. 6 is a block circuit diagram illustrating a dual-polarization optical front end according to an example embodiment.

FIG. 7 is a flowchart illustrating a method of generating a digital representation of a received on-off keyed optical signal according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized, and that structural, logical and electrical changes may be made without departing from the scope of the present invention. The following description of example embodiments is, therefore, not to be taken in a limited sense, and the scope of the present invention is defined by the appended claims.

Prior optical receiver front-end architectures did not allow for coherent phase recovery of received optical on/off-keying (OOK) signals. Prior research has indicated that carrier phase recovery may be possible if performed in the optical analog domain via beat detection to phase lock a receiver laser to a pulsed transmitter laser. However, such work does not shed light on how to perform phase recovery when the local mixing laser is not physically locked input signal carrier frequency in the analog domain.

For OOK receivers, there is an opportunity to realize a communications performance improvement as long as both symbol timing and carrier frequency/phase can be simultaneously resolved and recovered versus the straightforward approach of ignoring phase information altogether for the OOK modes and only performing magnitude-based timing recovery and demodulation.

An improved receiver system effectively and practically recovers both symbol timing and carrier frequency/phase using customized digital signal processing (DSP) techniques and algorithms, resulting in an example improvement of approximately 2 dB over straightforward approaches. In one example, an all-digital approach may use a coherent optical receiver front end with analog signal processing approaches.

The improved receiver system may be used for optical intersatellite nodes, fiberoptic communications using OOK, or PPM (pulse position modulation) modulation, and/or even simultaneous laser ranging and communication (LiDAR (light detection and ranging)+Comm).

The improved receiver system may also be used in the wireless RF (radio frequency) and microwave spaces, OOK and PPM are used mainly in low cost, power efficient applications, such as remote controls, garage door openers, wireless doorbells, keyfobs, etc in the ISM band, but it could also be useful in low power sensor networks where the receiving base station can tolerate higher complexity in cost to enable better performance, but the high volume of transmitter modules would benefit greatly from lower cost.

In one example, the improved receiver system performs a coherent detection for what would be considered an intensity modulated waveform. The improved receiver includes a coherent optical front-end receiver that utilizes a reference laser LO (locally mixed) and quadrature detection of either a polarization-invariant or dual polarization signal using either single or double-balanced photodetectors/outputs to process a received intensity modulated waveform, such as an OOK optical waveform. A symbol/slot timing recovery circuit includes a timing error detector, a loop filter, and a steered sampling oscillator (numerical or otherwise). A carrier frequency/phase recovery circuit, either feed-forward or feedback-based is used to recover the frequency and phase (e.g. PLL). Optionally, a dual polarization path combining circuit may be used where dual polarization is performed. A soft or hard decision demodulation circuit is used to provide a final digital output of the received intensity modulated waveform.

The improved receiver system is highly beneficial for free space optical communications such as OISL because OOK modulations are very common. Quantitatively, a 2 dB communication performance improvement can mean either ˜60% better transmitter power efficiency, or 2.5× further communication range, or a ˜2× better bit error rate, or a combination of improvement in any or all of these aspects. These improvements create a positive net impact to network performance and uptime and can therefore considerably reduce costs by permitting the use of fewer nodes in an infrastructure, especially impactful for expensive communication network infrastructure.

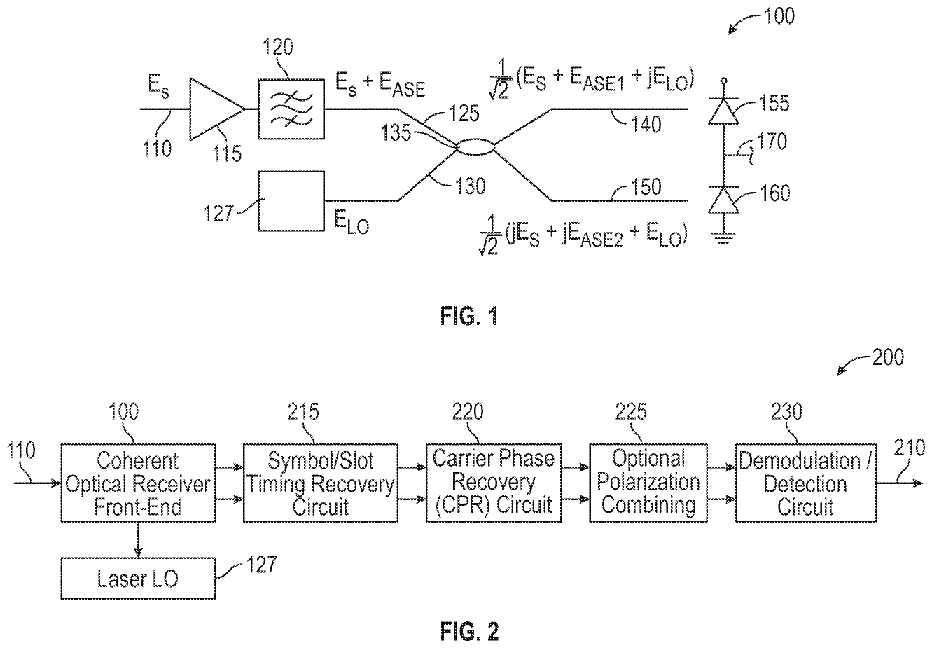

FIG. 1 is a block diagram of a coherent optical receiver front end 100. Front end 100 receives a OOK optical signal 110 labeled as E_{S} and amplifies the signal via an optical amplifier 115. The output from the optical amplifier 115 is filtered via a bandpass filter 120 tuned to a carrier frequency of the optical signal 110 to produce an amplified optical signal on line 125 having a value of E_{S}+E_{ASE}, where E_{ASE} is an amplified spontaneous emission that occurs when amplifying optical signals.

Receiver font end 100 includes a reference laser 127 that generates a reference E_{LO} signal 130 that is selected to match the carrier frequency. However, due to design tolerances and changes in the received optical signal 110, the reference E_{LO} signal 130 may not exactly match that received optical signal 110 in phase and/or frequency.

The signals are coupled at a coupler 135 to perform mixing and to generate coherent signals on line 140 ((1/(2⁻²)) (E_{S}+E_{ASE1}+jE_{LO})) and 150 ((1/(2⁻²)) (jE_{S}+jE_{ASE2}+E_{LO})), which are detected via balanced photo detectors 155 and 160 to generate a electrical output 170. Receiver front end 100 ensures the reference E_{LO} signal and received optical signal 110 are coherent for purposes of generating output 170 via photo detectors 155 and 160. The output 170 may then be further processed to produce a digital output for decoding. In other examples described in further detail below, the received optical signal and reference E_{LO} signals may be split into polarized signals, which are then detected by four balanced photo detectors prior to producing the output 170 in the form of an electrical signal representative of the received optical signal 110 and the reference E_{LO} signal 130. When polarized in that manner, polarization combining may be performed prior to demodulation.

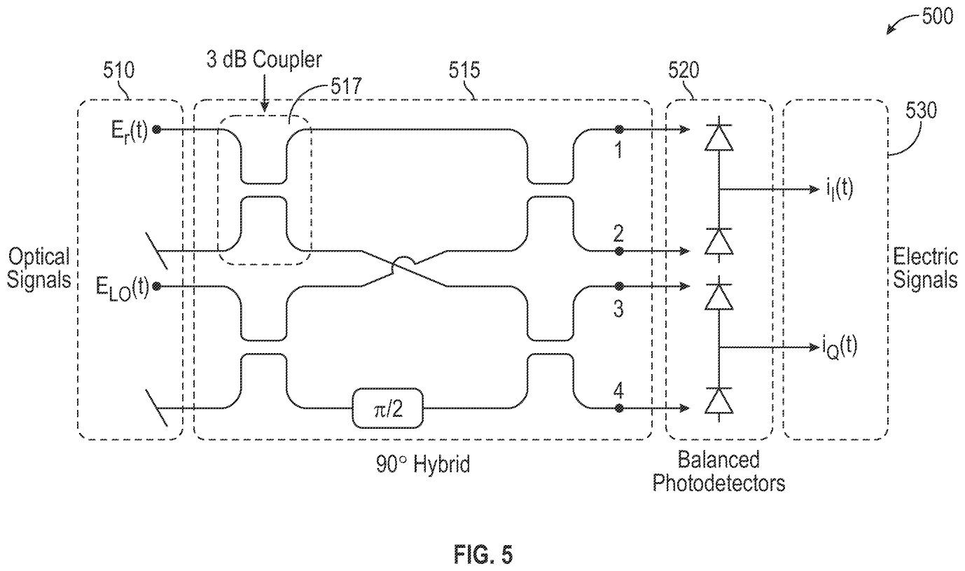

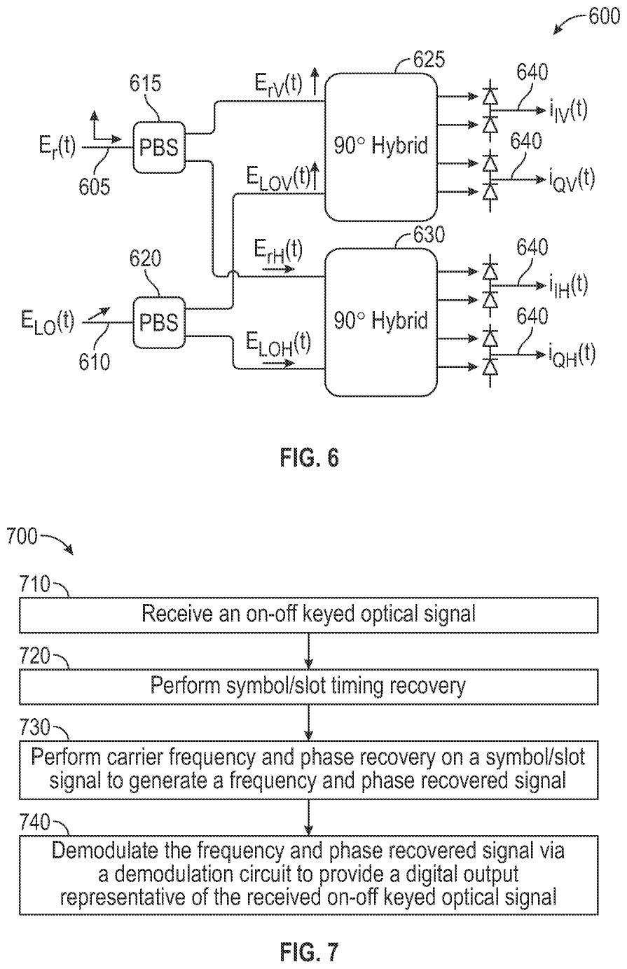

FIG. 2 is a block diagram illustrating a receiver system 200 that includes a receiver front end 205 providing output 170 to further circuitry for producing a final digital output 210 representative of data encoded in the received optical signal 110. Front end 205 has been modified from front end 100 to include quadrature detection as described with respect to front ends 500 and 600 in FIGS. 5 and 6. The further circuitry of system 200 includes a symbol/slot timing recovery circuit 215, carrier phase recovery (CPR) circuitry 220, an optional polarization combining circuit 225, and a demodulation/detection circuit 230.

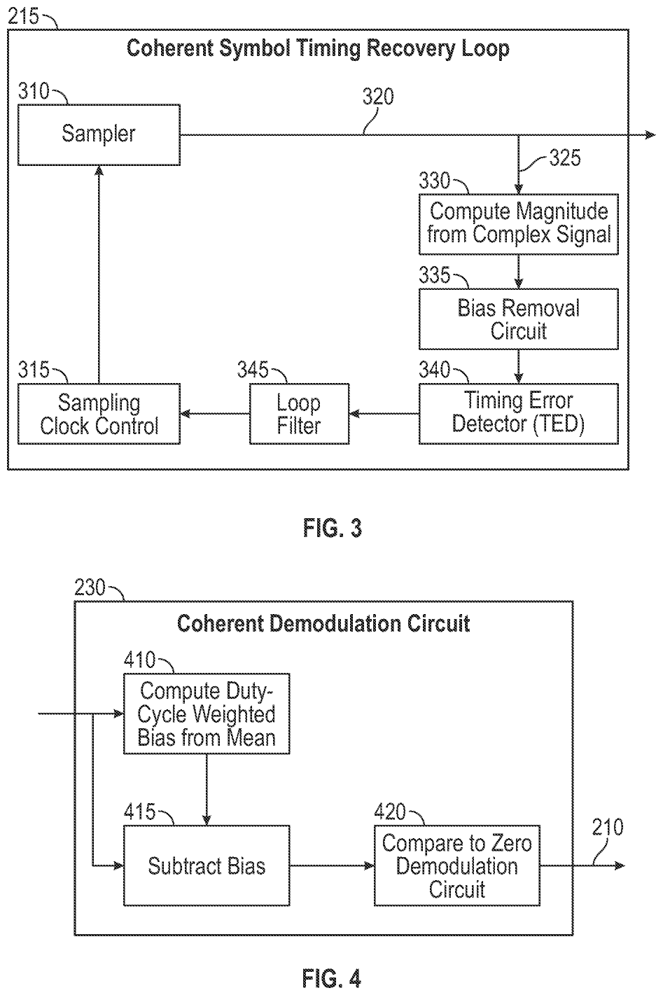

FIG. 3 is a block diagram of the symbol/slot timing recovery circuit 215. A sampler 310 receives the output of the front end 205. The sampler 310 is controlled by a sampling clock control 315 and produces a complex signal 320. A symbol timing recovery loop 325 includes a computing circuit 330 that receives the complex signal 320 and computes a magnitude of the complex signal 320, which is provided to a bias removal circuit 335. Output of the bias removal circuit 335 is provided to a timing error detector (TED) 340. Output of the TED 340 is provided to a loop filter 345, which provides a filtered signal 345 to the sampling clock control 315, completing the symbol timing recovery loop 325.

The symbol timing recovery circuit is used to coherently recover phase and demodulate a received OOK signal. Circuits 330 and 335 have been added to the symbol timing recovery loop 325 to obtain complex-valued samples and magnitude values from the OOK sampled signals. The magnitude computation and bias removal are applied only on input to the timing error detector within the symbol timing recovery loop, but the complex-valued samples are passed out to the carrier phase recover circuitry 220 for phase recovery processing.

The CPR circuit 215 can take a variety of forms. One form could be that of the Viterbi & Viterbi CPR algorithm modified to meet the input for OOK receivers in any of its transmitted optical variants. Another would be to use a phase-locked loop (PLL) circuit in conjunction with the input. In this case, there is a novelty in gating the output of the phase error detector that feeds in to the PLL loop filter to improve performance specifically for higher order PPM modes, which has been modeled and simulated to show its improved performance versus non-gating techniques. There are also decision-directed and blind phase search algorithms that can be used for CPR.

Finally, for certain CPR algorithms that feed phase estimates back it is possible to apply these estimates prior to the symbol timing recovery circuit 215, effectively becoming a joint timing and phase recovery loop that allows both tracking loops to converge in cooperation and possibly lead to even better performance. There are generally known practical and other performance benefits to joint tracking loop operation, though the desired form would adaptively disable the complex magnitude operation prior to timing error detector 340 after locking the carrier phase digitally to improve the symbol timing recovery error estimates and would be particularly useful for common pointing-induced fading scenarios experienced in free-space optical communication links.

FIG. 4 is a block diagram of the demodulation/detection circuit 230. The demodulation/detection circuit 230 is modified from prior demodulation/detection circuits as a decision threshold is no longer inherently zero and the coherent bias should be calculated directly from a measured mean and a modulation specific parameter at a bias calculation circuit 410 and removed by a subtract bias circuit 415 prior to a compare to zero demodulation circuit 420.

FIG. 5 is a block circuit diagram illustrating a polarization-invariant optical front end 500. System 500 receives input and reference optical signals 510 and couples the optical signals 510 to a 90 degree hybrid 515 via a 3 dB coupler 517. The 90-degree hybrid 515 performs quadrature mixing. Balanced photodetector 520 convert the optical signals 510 to electric signals 530. Electric signals 530 may be provided by ADC converters coupled to the output of the balanced photodetectors 520. The output of the ADC converters may then be further processed to perform symbol/slot timing recovery, carrier phase recovery, and finally demodulation to produce a digital output as shown in FIG. 2.

FIG. 6 is a block circuit diagram illustrating a dual-polarization optical front end 600. Front end 600 also receives input and reference optical signals 605 and 610, each of which are coupled to respective polarization beam splitter (PBS) circuits 615 and 620 to provide dual polarizations. Output from PBS circuits 615 and 620 comprise polarized signals with the signals of the same polarization provided to respective 90 degree hybrids 625 and 630 to provide quadrature mixing, resulting in eight outputs provided to photodetectors 635 to provide four output signals 640 for quadrature detection. In one example, dual-polarization paths, dual quadrature mixing, dual differential balanced photodetection, and four ADC channels are used to provide the output signals 640. The output of the ADC converters may then be further processed to perform symbol/slot timing recovery, carrier phase recovery, and finally demodulation to produce a digital output as shown in FIG. 2.

With dual-polarization front end input there is more than one input that is processed compared to previous OOK based receivers.

The improved coherent OOK receiver may be used in microwave/radio communications applications in addition to optical communications such as for use in low power sensor networks here if those transmitters can be simplified or even use PPM modes more heavily to become even more power efficient, with minimal effect on the receiver network complexity, but greatly increased relative range.

Traditionally, optical OOK demodulation utilizes a direct detection receiver architecture due to its simplicity. When the more complex coherent receiver architecture is used instead such as is done in Space BACN since other coherent modes are already supported, there is an opportunity to realize a communications performance improvement in the OOK modes as long as both symbol timing and carrier frequency/phase can be simultaneously resolved and recovered since any received symbol with large negative component would no longer be flipped to cross the decision threshold.

FIG. 7 is a flowchart illustrating a method 700 of generating a digital representation of a received on-off keyed optical signal. Method 700 begins at operation 710 by receiving an on-off keyed optical signal via a coherent optical front-end receiver utilizing a locally mixed laser LO for a reference signal to perform quadrature detection of the optical signal to generate an electrical signal. In one example, quadrature detection may be performed once for the received optical signal without any polarization splitting. In a further example, quadrature detection may be performed separately for dual orthogonal polarizations of the of the received optical signal.

Operation 720 performs symbol/slot timing recovery on the electrical signal using a timing error detector. The timing error detector gates an output on a per symbol basis by utilizing symbol timing alignment information fed back from a downstream symbol synchronizer of the demodulation circuit. Carrier frequency and phase recovery is performed at operation 730 on a symbol/slot signal to generate a frequency and phase recovered signal. Carrier frequency and phase recovery may be performed continuously tracking and removing carrier and phase offset from the time aligned signal. Symbol/slot timing recovery in one example is based on the quadrature detection of the optical signal using a timing error detector to provide a time aligned signal. In one example phase correction is applied prior to symbol timing error detection.

Operation 740 demodulates the frequency and phase recovered signal via a demodulation circuit to provide a digital output representative of the received on-off keying optical signal.

Operation 720 may be performed by calculating a complex magnitude and removes bias prior to performing timing error detection. In one example, bias is not removed for performing carrier frequency and phase recovery.

Removing bias in operation 720 may be performed by calculating a bias estimate as a mean, median, or highest m-quantile of the complex magnitude, where m is an on-off keyed modulation order.

In one example, a locally mixed laser LO may be tuned to a selected carrier frequency.

### EXAMPLES

Example 1 is a method that includes receiving an on-off keyed optical signal via a coherent optical front-end receiver utilizing a locally mixed laser LO for a reference signal to perform quadrature detection of the optical signal to generate an electrical signal. Symbol/slot timing recovery are performed on the electrical signal using a timing error detector. Carrier frequency and phase recovery are performed on a symbol/slot signal to generate a frequency and phase recovered signal. The frequency and phase recovered signal are demodulated via a demodulation circuit to provide a digital output representative of the received on-off keyed optical signal.

Example 2 includes the method of example 1 wherein performing symbol/slot timing recovery is based on the quadrature detection of the optical signal using a timing error detector to provide a time aligned signal.

Example 3 includes the method of example 2 wherein performing carrier frequency and phase recovery comprises continuously tracking and removing carrier and phase offset from the time aligned signal.

Example 4 includes the method of any of examples 2-3 and further comprising calculating a complex magnitude and removing bias prior to performing timing error detection.

Example 5 includes the method of example 4 wherein magnitude calculation and bias removal are avoided to enable performing carrier frequency and phase recovery.

Example 6 includes the method of example 5 wherein removing bias is performed by calculating a bias estimate as a mean, median, or highest m-quantile of the complex magnitude, where m is an on-off keyed modulation order.

Example 7 includes the method of any of examples 2-6 wherein the timing error detector gates an output on a per symbol basis by utilizing symbol timing alignment information fed back from a downstream symbol synchronizer of the demodulation circuit.

Example 8 includes the method of any of examples 1-7 wherein phase correction is applied prior to symbol timing error detection.

Example 9 includes the method of any of examples 1-8 and further comprising tuning the locally mixed laser LO to a selected carrier frequency.

Example 10 includes the method of any of examples 1-9 wherein quadrature detection is performed once for the received optical signal without any polarization splitting.

Example 11 includes the method of any of examples 1-10 wherein quadrature detection is performed separately for dual orthogonal polarizations of the of the received optical signal.

Example 12 is an optical receiver system that includes a coherent optical front-end receiver utilizing a locally mixed laser LO for a reference signal to perform quadrature detection of an on-off keyed received optical signal to generate an electrical signal. A timing error detector circuit is configured to receive the electrical signal and perform symbol/slot timing recovery. A carrier phase recovery circuit is configured to perform carrier frequency and phase recovery on a symbol/slot aligned signal to generate a frequency and phase recovered signal. A demodulation circuit is configured to receive and demodulate the frequency and phase recovered signal to provide a digital output representative of the received on-off keyed optical signal.

Example 13 includes the system of example 12 wherein the timing error detector is configured to perform symbol/slot timing recovery based on the quadrature detection of the optical signal and subsequently provide a time aligned signal.

Example 14 includes the system of example 13 wherein carrier phase recovery circuit is further configured to perform carrier frequency and phase recovery by continuously tracking and removing carrier and phase offset from the time aligned signal.

Example 15 includes the system of any of examples 12-14 wherein the timing error detector circuit is further configured to calculate a complex magnitude and remove bias prior to performing timing error detection.

Example 16 includes the system of any of examples 12-15 wherein magnitude calculation and bias removal are avoided to enable performing carrier frequency and phase recovery.

Example 17 includes the system of example 16 wherein the timing error detector circuit is further configured to remove bias from the complex magnitude by a bias estimate as the mean, median, or highest m-quantile of the complex magnitude, where m is an on-off keyed modulation order.

Example 18 includes the system of any of examples 16-17 wherein the timing error detector circuit gates an output on a per symbol basis by utilizing symbol timing alignment information fed back from a downstream symbol synchronizer of the demodulation circuit.

Example 19 includes the system of any of examples 12-18 wherein the carrier phase recovery circuit is further configured to perform phase error correction prior to symbol timing error detection.

Example 20 includes the system of any of examples 12-19 wherein quadrature detection is performed separately for dual orthogonal polarizations of the on-off keyed received optical signal.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
receiving an on-off keyed optical signal via a coherent optical front-end receiver utilizing a locally mixed laser LO for a reference signal to perform quadrature detection of the optical signal to generate an electrical signal;
performing symbol/slot timing recovery on the electrical signal using a timing error detector;
performing carrier frequency and phase recovery on a symbol/slot signal to generate a frequency and phase recovered signal; and
demodulating the frequency and phase recovered signal via a demodulation circuit to provide a digital output representative of the received on-off keyed optical signal.

2. The method of claim 1 wherein performing symbol/slot timing recovery is based on the quadrature detection of the optical signal using a timing error detector to provide a time aligned signal.

3. The method of claim 2 wherein performing carrier frequency and phase recovery comprises continuously tracking and removing carrier and phase offset from the time aligned signal.

4. The method of claim 2 and further comprising calculating a complex magnitude and removing bias prior to performing timing error detection.

5. The method of claim 4 wherein magnitude calculation and bias removal are avoided in the time-aligned signal to enable performing carrier frequency and phase recovery.

6. The method of claim 5 wherein removing bias is performed by calculating a bias estimate as a mean, median, or highest m-quantile of the complex magnitude, where m is an on-off keyed modulation order.

7. The method of claim 2 wherein the timing error detector gates an output on a per symbol basis by utilizing symbol timing alignment information fed back from a downstream symbol synchronizer of the demodulation circuit.

8. The method of claim 1 wherein phase correction is applied prior to symbol timing error detection.

9. The method of claim 1 and further comprising tuning the locally mixed laser LO to a selected carrier frequency.

10. The method of claim 1 wherein quadrature detection is performed once for the received optical signal without any polarization splitting.

11. The method of claim 1 wherein quadrature detection is performed separately for dual orthogonal polarizations of the of the received optical signal.

12. An optical receiver system comprising:
a coherent optical front-end receiver utilizing a locally mixed laser LO for a reference signal to perform quadrature detection of an on-off keyed received optical signal to generate an electrical signal;
a timing error detector circuit configured to receive the electrical signal and perform symbol/slot timing recovery;
a carrier phase recovery circuit configured to perform carrier frequency and phase recovery on a symbol/slot aligned signal to generate a frequency and phase recovered signal; and
a demodulation circuit configured to receive and demodulate the frequency and phase recovered signal to provide a digital output representative of the received on-off keyed optical signal.

13. The system of claim 12 wherein the timing error detector is configured to perform symbol/slot timing recovery based on the quadrature detection of the optical signal and subsequently provide a time aligned signal.

14. The system of claim 13 wherein carrier phase recovery circuit is further configured to perform carrier frequency and phase recovery by continuously tracking and removing carrier and phase offset from the time aligned signal.

15. The system of claim 12 wherein the timing error detector circuit is further configured to calculate a complex magnitude and remove bias prior to performing timing error detection.

16. The system of claim 12 wherein magnitude calculation and bias removal are avoided in the time-aligned signal to enable performing carrier frequency and phase recovery.

17. The system of claim 16 wherein the timing error detector circuit is further configured to remove bias from the complex magnitude by a bias estimate as the mean, median, or highest m-quantile of the complex magnitude, where m is an on-off keyed modulation order.

18. The system of claim 16 wherein the timing error detector circuit gates an output on a per symbol basis by utilizing symbol timing alignment information fed back from a downstream symbol synchronizer of the demodulation circuit.

19. The system of claim 12 wherein the carrier phase recovery circuit is further configured to perform phase error correction prior to symbol timing error detection.

20. The system of claim 12 wherein quadrature detection is performed separately for dual orthogonal polarizations of the on-off keyed received optical signal.
